(19) United States
(12) Patent Application Publication
(10) Pub. No.: US 2004/0036044 A1
(43) Pub. Date: Feb. 26, 2004

(54) Differential pressure control valve

(75) Inventor: Hisatoshi Hirota, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TGK CO., LTD., Tokyo (JP)

(21) Appl. No.: 10/642,270

(22) Filed: Aug. 18, 2003

(30) Foreign Application Priority Data
Aug. 22, 2002 (JP) 2002-242084

(51) Int. Cl. F16K 31/383

(52) U.S. Cl. 251/30.02

(57) ABSTRACT

The object of the present invention is to provide a differential pressure control valve capable of preventing refrigerant from leaking along the outer periphery of a piston for actuating a main valve. An annular diaphragm has an inner peripheral edge portion clamped between a main valve piston and a fixing ring secured to the main valve piston, and an outer peripheral edge portion clamped between a body and a cylindrical member secured to the body, and the cylindrical member slidably receives the main valve piston. Thus, the outer periphery of the main valve piston is completely sealed by the diaphragm and inlet pressure P1 is introduced from a refrigerant introduction chamber into a piston chamber only through an orifice, whereby characteristics of the differential pressure control valve can be stabilized.

### CROSS-REFERENCES TO RELATED APPLICATIONS, IF ANY

This application claims priority of Japanese Application No.2002-242084 filed on Aug. 22, 2002 and entitled “Differential Pressure Control Valve”.

### BACKGROUND OF THE INVENTION

(1) Field of the Invention

The present invention relates to a differential pressure control valve for controlling flow rate so that a differential pressure between inlet and outlet sides thereof may become equal to a differential pressure set by a solenoid, and more particularly, to a differential pressure control valve suitable for use as a pressure reducing device in the refrigerating cycle of an automotive air conditioner.

(2) Description of the Related Art

As a refrigerating cycle of an automotive air conditioning system, for example, there has been known a configuration wherein high-temperature, high-pressure gaseous refrigerant compressed by a compressor is condensed or cooled by a condenser or a gas cooler, the condensed or cooled refrigerant is turned into low-temperature, low-pressure refrigerant by a pressure reducing device, the low-temperature refrigerant is evaporated by an evaporator, the evaporated refrigerant is separated into gas and liquid by an accumulator, and the separated gaseous refrigerant is returned to the compressor. In such systems, a differential pressure control valve is often used as the pressure reducing device.

In the refrigerating cycle using carbonic acid gas as the refrigerant, for example, the pressure of the refrigerant to be controlled is extremely high as compared with the refrigerating cycle using an alternative fluorocarbon as the refrigerant, thus requiring a huge solenoid for directly controlling the valve element. Accordingly, a differential pressure control valve used in such cycles as the pressure reducing device has a construction similar to a flow regulating valve of pilot-operated type.

As disclosed in Japanese Unexamined Patent Publication No. 2001-27355, for example, a conventional pilot-operated differential pressure control valve comprises a main valve arranged between inlet and outlet ports, a piston arranged in alignment with the main valve and movable in an axial direction thereof together with a main valve element of the main valve, and a pilot valve for controlling the pressure in a piston chamber located on one side of the piston opposite the main valve element. High-pressure refrigerant is introduced from the inlet port into the piston chamber through the pilot valve, and the thus-introduced refrigerant is allowed to leak to the outlet port through an orifice formed in the piston. At this time, the piston, which is received in a cylinder bore, slides in the axial direction along the cylinder bore in accordance with a difference between the pressures in the piston chamber and the outlet port. The movement of the piston is transmitted to the main valve element of the main valve through a shaft inserted through a valve hole of the main valve, to control the valve lift of the main valve. When the amount of refrigerant introduced into the piston chamber is increased by the pilot valve, the piston moves the main valve element of the main valve in the valve opening direction. Conversely, when the valve lift of the pilot valve is controlled to be smaller, the amount of refrigerant introduced into the piston chamber decreases and thus the piston moves the main valve element in the valve closing direction.

The pilot valve is actuated by a solenoid and its valve lift is set by a spring built into the solenoid and the value of electric current passed through the solenoid. The valve lift of the pilot valve serves to set a differential pressure between the inlet and outlet sides of the main valve. Consequently, the differential pressure control valve controls the flow rate of refrigerant so that the differential pressure between the inlet and outlet sides may become equal to the set constant differential pressure.

In the conventional pilot-operated differential pressure control valve, the main valve element is actuated by the piston slidably received in the cylinder bore. The piston has a piston ring fitted around an outer peripheral surface thereof to restrain the refrigerant introduced into the piston chamber from leaking to the outlet port side along the outer periphery of the piston. However, the piston ring is disconnected at a part thereof and does not enclose the piston over the entire circumference thereof for sealing. Accordingly, the refrigerant inevitably leaks from the disconnected part of the piston ring, making it necessary to increase the diameter of the orifice that substantially leaks the refrigerant from the piston chamber to the outlet port. In addition, where the piston ring is made of a material having the property of swelling on absorption of the refrigerant, the gap of the disconnected part of the piston ring changes, causing variation in the amount of leakage of the refrigerant, and therefore, a problem arises in that the differential pressure-flow rate characteristic changes.

### SUMMARY OF THE INVENTION

The present invention was created in view of the above circumstances, and an object thereof is to provide a differential pressure control valve capable of preventing leak of refrigerant along an outer periphery of a piston for actuating a main valve.

To solve the above problems, the present invention provides a differential pressure control valve of pilot-operated type for controlling a flow rate of fluid so that a differential pressure between inlet and outlet sides of the fluid may become equal to a differential pressure set by a value of electric current passed through a solenoid thereof, the differential pressure control valve being characterized in that a diaphragm is arranged at a sliding portion on an outer periphery of a main valve piston for opening and closing a main valve element of a main valve, to completely prevent the fluid from leaking through the sliding portion.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a longitudinal sectional view showing the arrangement of a differential pressure control valve according to a first embodiment of the present invention.

FIG. 2 is an enlarged sectional view showing part A in FIG. 1.

FIG. 3 is a longitudinal sectional view showing the arrangement of a differential pressure control valve according to a second embodiment of the present invention.

### DESCRIPTION OF THE PREFERRED EMBODIMENTS

Embodiments of the present invention will be hereinafter described in detail with reference to the drawings, wherein the invention is applied, by way of example, to a pressure reducing device of differential pressure control type whose set differential pressure between inlet and outlet sides can be freely set by an external signal.

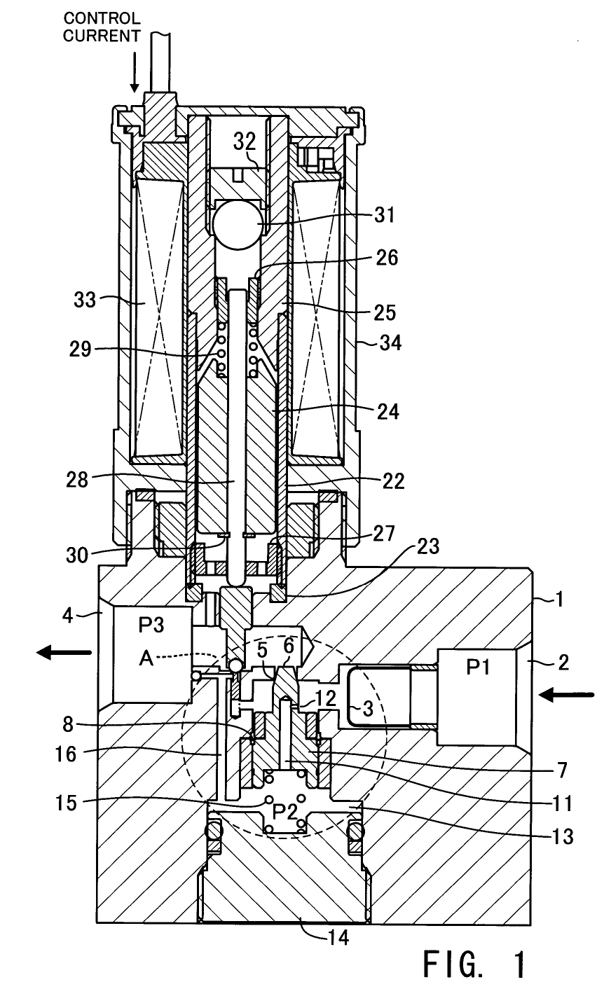

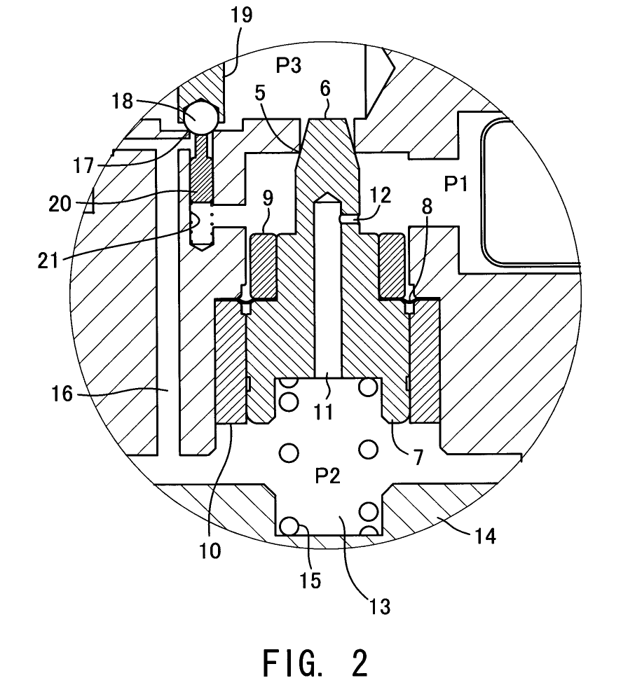

FIG. 1 is a longitudinal sectional view showing the arrangement of a differential pressure control valve according to a first embodiment of the present invention, and FIG. 2 is an enlarged sectional view showing part A in FIG. 1.

The differential pressure control valve according to the present invention has an inlet port 2 formed on a side face of a body 1 for receiving refrigerant under high inlet pressure P1. A strainer 3 is arranged in the inlet port 2 so as to cover a passage therein. An outlet port 4 is formed on the other side of the body 1 opposite the inlet port 2, and a main valve seat 5 formed integrally with the body 1 is located between the inlet and outlet ports. A main valve element 6 is arranged so as to face the main valve seat 5 from the upstream side and constitutes, in cooperation with the main valve seat 5, a main valve. The main valve element 6 is formed integrally with a main valve piston 7 as a one-piece body, and the main valve piston 7 opens and closes the main valve element 6. The main valve piston 7 is movable in directions such that the main valve element 6 can be brought into contact with and separated from the main valve seat 5, and a refrigerant introduction chamber is defined between the main valve piston 7 and the main valve seat 5.

The main valve piston 7 has an upper small-diameter part and a lower large-diameter part, as viewed in the figures, with a shoulder located therebetween. On the shoulder is placed an inner peripheral edge portion of an annular diaphragm 8, and a fixing ring 9 is tightly fitted round the small-diameter part of the main valve piston 7 from above the diaphragm 8, thereby fixing the inner peripheral portion of the diaphragm 8 to the main valve piston 7. An outer peripheral edge portion of the diaphragm 8 is fixed to the body 1 by a cylindrical member 10 which is press fitted in the body 1 and which slidably receives the main valve piston 7. In this manner, the diaphragm 8 is arranged so as to isolate the sliding portion of the main valve piston 7, whereby leak of the refrigerant via the sliding portion of the main valve piston 7 is completely prevented. For the diaphragm 8, a polyimide film having high tensile strength is preferably used.

The main valve piston 7 has a refrigerant passage 11 formed therein along its axis, and the refrigerant passage 11 communicates with the refrigerant introduction chamber through an orifice 12 laterally penetrating the main valve element 6. The orifice 12 serves to reduce the inlet pressure P1 in the refrigerant introduction chamber and constitutes, in cooperation with the refrigerant passage 11, a restricted flow passage leading to a piston chamber 13 defined beneath the main valve piston 7, as viewed in the figures. The restricted flow passage alone exists between the refrigerant introduction chamber and the piston chamber 13, and the flow area of the orifice 12 is fixed, whereby characteristics of the differential pressure control valve can be stabilized.

The piston chamber 13 is closed with an adjusting screw 14, and a spring 15 is arranged between the main valve piston 7 and the adjusting screw 14 to urge the main valve piston 7 in a direction of closing the main valve. The adjusting screw 14 is screwed into the body 1 so that the load applied to the spring 15 may be adjustable.

The piston chamber 13 communicates, through a pilot passage 16 formed in the body 1, with a downstream side of the main valve, that is, a space connecting with the outlet port 4. An open end of the pilot passage 16 opening into the space connecting with the outlet port 4 serves as a pilot valve seat 17. A ball-shaped pilot valve element 18 is arranged so as to face the pilot valve seat 17 from the downstream side and constitutes, in cooperation with the pilot valve seat 17, a pilot valve. The pilot valve element 18 is held by a shaft 19 movable toward and away from the pilot valve seat 17.

A pilot piston 20 is axially movably arranged in alignment with the pilot valve and is urged at a lower end thereof by a spring 21 such that an upper end thereof is in urging contact with the pilot valve element 18. A chamber containing the spring 21 communicates with the refrigerant introduction chamber, and accordingly, the inlet pressure P1 acts upon the pilot piston 20 in a direction of opening the pilot valve.

The pilot piston 20 is received in a cylinder having an inner diameter equal to that of a valve hole of the pilot valve seat 17 so that the pilot valve element 18 and the pilot piston 20 may have an equal pressure receiving area. Thus, the pilot valve element 18 and the pilot piston 20 receive the same intermediate pressure P2 in the piston chamber 13 but in opposite directions. The intermediate pressure P2 therefore exerts no influence upon the movement of the pilot valve, allowing the pilot valve to move solely in response to a differential pressure between the inlet pressure P1 and an outlet pressure P3.

A solenoid for controlling the pilot valve is arranged on the body 1 and has a sleeve 22 positioned in alignment with the pilot valve. The sleeve 22 has a lower end pressed against a ring-shaped packing 23 to seal the joint with the body 1 from outside.

A plunger 24 is axially movably arranged in the sleeve 22 and a core 25 is secured to an upper end portion of the sleeve 22 so as to close the sleeve. The core 25 is a hollow member and has a bearing 26 screwed in the hollow. The bearing 26 cooperates with a bearing 27 screwed into a lower part of the sleeve 22 to support, at two points, both ends of a shaft 28 supporting the plunger 24, in a manner such that the outer peripheral surface of the plunger 24 does not come into contact with the inner wall of the sleeve 22, thereby reducing sliding resistance. A spring 29 is arranged between the plunger 24 and the bearing 26 and urges the plunger 24 toward the pilot valve. The load on the spring 29 is adjusted by varying the distance for which the bearing 26 is screwed in. The plunger 24 urged by the spring 29 has a lower end face butted against an E ring 30 fitted on the shaft 28, and accordingly, the urging force of the spring 29 is transmitted to the shaft 28, which in turn urges the pilot valve in the valve closing direction.

An upper open end of the core 25 is closed with a stop plug 31 and a locking screw 32. The sleeve 22 and the core 25 are surrounded by an electromagnetic coil 33, which in turn is surrounded by a case 34 serving as a yoke. The case 34 is screwed on an upper part of the body 1.

In the differential pressure control valve constructed in this manner, when no current is passed through the electromagnetic coil 33 and no refrigerant is introduced into the inlet port 2, the main valve element 6 is seated on the main valve seat 5 by the action of the spring 15 and thus the main valve is in a closed state. The pilot valve element 18 is also seated on the pilot valve seat 17 by the action of the spring 29 having a larger spring force than the spring 21, and accordingly, the pilot valve is in a closed state.

As the high-pressure refrigerant with the inlet pressure P1 is introduced into the inlet port 2, the refrigerant flows into the refrigerant introduction chamber surrounding the upper part of the main valve piston 7. The pilot piston 20 receives the inlet pressure P1 at its lower end face, but since the pressure receiving area is small, the pilot piston 20 fails to lift the pilot valve element 18 open even if assisted by the inlet pressure P1, with the result that the pilot valve remains fully closed. The refrigerant introduced into the refrigerant introduction chamber gradually flows into the piston chamber 13 defined beneath the main valve piston 7 only through the orifice 12 of the main valve element 6 and the refrigerant passage 11 of the main valve piston 7. Consequently, the intermediate pressure P2 in the piston chamber 13 gradually rises and is introduced to the pilot valve through the pilot passage 16 formed in the body 1. The intermediate pressure P2 exerts no influence on the movement of the pilot valve.

Subsequently, a predetermined control current is supplied to the electromagnetic coil 33 of the solenoid, whereupon the plunger 24 is attracted toward the core 25. Since the force of the spring 29 urging the pilot valve element 18 in the valve closing direction is reduced, the pilot piston 20 lifts the pilot valve element 18 with the aid of the inlet pressure P1 and sets the pilot valve to a predetermined valve lift. Consequently, the refrigerant in the piston chamber 13 flows into the outlet port 4 through the pilot valve, so that the intermediate pressure P2 lowers. Since the intermediate pressure P2 in the piston chamber 13 lowers, the main valve piston 7 moves downward, as viewed in the figures, against the urging force of the spring 15. Accordingly, the main valve opens and the refrigerant introduced into the inlet port 2 flows to the outlet port 4 through the main valve.

While in this state, the pilot piston 20 and pilot valve element 18 of the pilot valve operate in response to a differential pressure between the inlet and outlet pressures P1 and P3. Specifically, if the inlet pressure P1 rises, the pilot piston 20 moves the pilot valve in the valve opening direction to decrease the pressure in the piston chamber 13. Accordingly, the main valve piston 7 moves downward, as viewed in the figures, to open the main valve wider and thereby decrease the inlet pressure P1. Conversely, if the inlet pressure P1 lowers, the pilot piston 20 moves the pilot valve in the valve closing direction to raise the pressure in the piston chamber 13, and accordingly, the main valve piston 7 moves upward, as viewed in the figures, to reduce the opening of the main valve and thereby increase the inlet pressure P1. In consequence, the refrigerant introduced into the inlet port 2 is controlled such that the differential pressure between the inlet and outlet pressures P1 and P3 is kept constant. Moreover, the pilot piston 20 of the pilot valve directly receives the inlet pressure P1 and thus pressure variation in the inlet port 2 is transmitted to the pilot valve in real time. Accordingly, the pilot valve moves with high sensitivity in response to variation in the inlet pressure P1, and the main valve operates in response to the movement of the pilot valve. Since the main valve operates in response to variation of the inlet pressure P1 nearly in real time, hunting can be restrained.

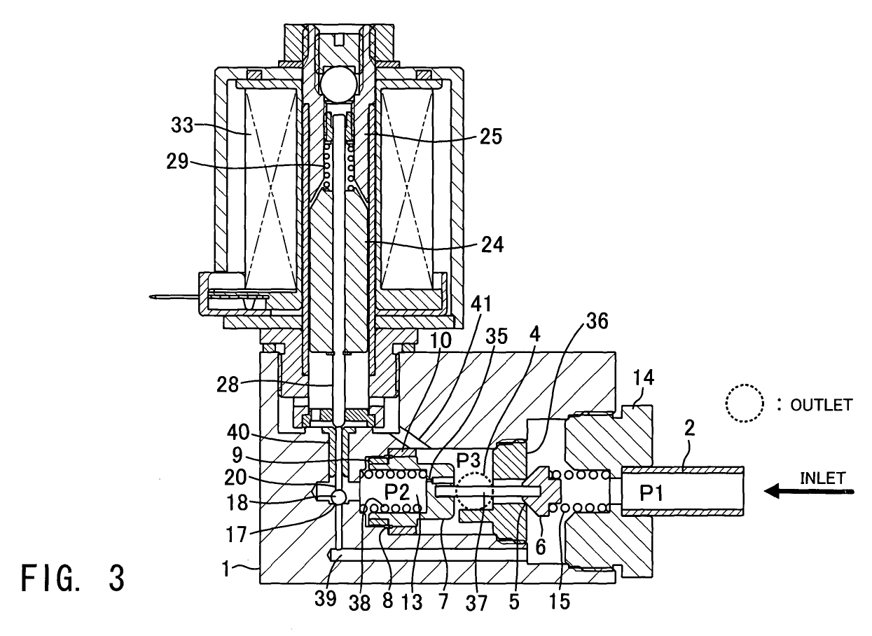

FIG. 3 is a longitudinal sectional view showing the arrangement of a differential pressure control valve according to a second embodiment of the present invention. In FIG. 3, identical reference numerals are used to denote elements having functions identical or equivalent to those of elements shown in FIGS. 1 and 2, and detailed description of such elements is omitted.

While in the differential pressure control valve of the first embodiment, pressure is introduced into the piston chamber 13 through the orifice 12 and is discharged from the piston chamber 13 through the pilot valve, the differential pressure control valve of the second embodiment is constructed such that pressure is introduced into the piston chamber 13 through a pilot valve and is discharged from the piston chamber 13 through an orifice 35 formed in the main valve piston 7.

The differential pressure control valve has a plug 36 fitted therein to define a refrigerant introduction chamber in a space communicating with the inlet port 2. The plug 36 has a valve hole of the main valve formed therethrough along an axis thereof, and the main valve element 6 is arranged so as to face the main valve seat 5 from the upstream side and can be brought into contact with and separated from the main valve seat 5. The main valve element 6 is urged by the spring 15 in the valve closing direction. The main valve piston 7 having a larger pressure receiving area than the main valve element 6 is axially movably arranged on the downstream side of the main valve in alignment therewith. The main valve piston 7 is coupled to the main valve element 6 by a shaft 37 extending through the valve hole of the main valve. A space between the plug 36 and the main valve piston 7 communicates with the outlet port 4.

The main valve piston 7 is a hollow member opening at one end thereof opposite the plug 36, and the hollow constitutes the piston chamber 13. A spring 38 is arranged in the piston chamber 13 and urges the main valve piston 7 in a direction of opening the main valve. Also, the main valve piston 7 has the orifice 35 connecting the piston chamber 13 and the outlet port 4.

The sliding portion of the main valve piston 7 is sealed by means of the diaphragm 8. Specifically, the diaphragm 8 has an inner peripheral edge portion clamped between the main valve piston 7 and the fixing ring 9, and has an outer peripheral edge portion clamped between the body 1 and the cylindrical member 10. The diaphragm 8 arranged in this manner permits axial movement of the main valve piston 7 and at the same time completely prevents the refrigerant from leaking via the sliding portion of the main valve piston 7.

The body 1 has a pilot passage 39 formed therein to connect the refrigerant introduction chamber located on the upstream side of the main valve to the piston chamber 13, and an open end of the pilot passage 39 opening into a space communicating with the piston chamber 13 serves as the pilot valve seat 17. In the space communicating with the piston chamber 13 is arranged the pilot valve element 18 which can be brought into contact with and separated from the pilot valve seat 17. The pilot valve element 18 is so arranged as to receive a solenoid-exerted force through the pilot piston 20 having an outer diameter equal to the inner diameter of the pilot valve seat 17. The pilot piston 20 is held by a holder 40 securely fitted in the body 1 and has a solenoid-side end face exposed to pressure in a space communicating with the outlet port 4 through a passage 41. Thus, the pilot valve element 18 and the pilot piston 20 receive the inlet and outlet pressures P1 and P3 and move in response to a differential pressure between these pressures.

In the differential pressure control valve constructed in this manner, when no current is supplied to the electromagnetic coil 33 and no refrigerant is introduced to the inlet port 2, the main valve and the pilot valve are both fully closed. While in this state, even if high-pressure refrigerant with the inlet pressure P1 is introduced to the inlet port 2, the fully closed state of the main valve is maintained because the pilot valve is closed.

When a predetermined control current is passed through the electromagnetic coil 33 of the solenoid, the plunger 24 is attracted toward the core 25 and thus the pilot valve element 18 and the pilot piston 20 are pushed upward by the inlet pressure P1, so that the pilot valve is set to a predetermined valve lift. Thus, the inlet pressure P1 is introduced into the piston chamber 13 through the pilot valve, and consequent increase of the intermediate pressure P2 causes the main valve piston 7 to open the main valve through the shaft 37. Consequently, the refrigerant introduced to the inlet port 2 flows to the outlet port 4 through the main valve.

While in this state, the pilot piston 20 and pilot valve element 18 of the pilot valve move in response to a differential pressure between the inlet and outlet pressures P1 and P3, and accordingly, the main valve, which operates in response to the movement of the pilot valve, controls the refrigerant introduced to the inlet port 2 such that the differential pressure between the inlet and outlet pressures P1 and P3 becomes constant.

As described above, the present invention has a construction such that the sliding portion of the main valve piston for actuating the main valve is sealed by means of the diaphragm. This prevents fluid from leaking along the outer periphery of the main valve piston for actuating the main valve, thus making it possible to stabilize the characteristics of the differential pressure control valve.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A differential pressure control valve of pilot-operated type for controlling a flow rate of fluid so that a differential pressure between inlet and outlet sides of the fluid may become equal to a differential pressure set by a value of electric current passed through a solenoid thereof,
characterized in that a diaphragm is arranged at a sliding portion on an outer periphery of a main valve piston for opening and closing a main valve element of a main valve, to completely prevent the fluid from leaking through the sliding portion.

2. The differential pressure control valve according to claim 1, characterized in that the diaphragm comprises a film shaped into annular form, the annular film having an inner peripheral edge portion clamped between the main valve piston and a fixing ring secured to the main valve piston, and an outer peripheral edge portion clamped between a body containing the main valve piston and a cylindrical member which is secured to the body and which slidably receives the main valve piston.

3. The differential pressure control valve according to claim 2, characterized in that the diaphragm comprises a polyimide film.

4. The differential pressure control valve according to claim 2, characterized in that the main valve piston is formed integrally with the main valve element as a one-piece body, and has an orifice connecting a space in which the fluid is introduced to a piston chamber located on one side thereof opposite the main valve element, pressure in the piston chamber being controlled by a pilot valve arranged between the piston chamber and a space located on a downstream side of the main valve, to thereby control valve lift of the main valve.

5. The differential pressure control valve according to claim 2, characterized in that the main valve piston is fixed to the main valve element by a shaft inserted through a valve hole of the main valve, and has an orifice connecting a space located on a downstream side of the main valve to a piston chamber located on one side thereof opposite the main valve element, pressure in the piston chamber being controlled by a pilot valve arranged between a space in which the fluid is introduced and the piston chamber, to thereby control valve lift of the main valve.
